(19) United States
(12) Patent Application Publication
(10) Pub. No.: US 2022/0035888 A1
(43) Pub. Date: Feb. 3, 2022

(54) JOURNEYING USER ACTIVITIES THROUGH A WEBSITE

(71) Applicant: Content Square SAS, Paris (FR)

(72) Inventors: Luis DIAZ, Paris (FR); Lionel SEGUIN, Paris (FR)

(73) Assignee: Content Square SAS, Paris (FR)

(21) Appl. No.: 16/943,439

(22) Filed: Jul. 30, 2020

(51) Int. Cl. G06F 16/958; G06Q 30/02; G06Q 30/06; H04L 29/08

(52) U.S. Cl. CPC G06F 16/972; H04L 67/22; G06Q 30/0641; G06Q 30/0201

(57) ABSTRACT

A system and method for journeying user activity through an online retail platform. The method includes analyzing pageviews recorded for each user of a plurality of users visiting a website; determining, for each user, a sequence of events recorded within each webpage visited; determining, for each user, a journey, wherein the journey is an order of webpage visits within the website; aggregating the determined sequences and the determined journeys across the plurality of users; and generating an intuitive map showing the aggregated journeys.

### TECHNICAL FIELD

The disclosure generally relates to monitoring browsing activity and, particularly, to sequencing a journey through a webpage.

### BACKGROUND

With the ubiquitous nature of the Internet, having a successful presence on the World Wide Web has become an indispensable tool for modern businesses and organizations. The commercial value of a website cannot be understated, as it provides perhaps the most easily-accessible portal through which current and potential clients can interact with a company, both through passive viewing and through active engagement, such as the purchasing of products and services and initiating contact with the company.

A website is a collection of web pages that are connected to each other using hypertext links. The links allow a user, or visitor, of the website to browse the various web pages of a website by selecting the links between the web pages. Users will often initially arrive at a homepage either from a search engine result or by directly entering the web address into a browser application, and make their way through the website until either the user performs a desired action, such as an online purchase, or the user leaves the website without performing such an action. Performing a desired action is referred to as a conversion, and the goal of many website owners and operators is to maximize the number of conversions from the users of their website.

In order to increase conversion rates, website owners often edit, modify, or change variables related to their websites in order to optimize a user's experience within the website. Such variables include the layout of each web page, the chosen color palette, the font choice, the size and placement of text, the choice of images and videos, the placement of appropriate offers or advertisements, and the like. Additionally, the removal of unused or distracting features can enhance the website user experience (UX) and, in turn, increase the conversion rate.

Programs for analyzing traffic from website visitors are known in the art. The programs typically monitor static data and generate reports for review. The data can include web server activity, such as the most popular page by number of visits, peak hours of website activity, the most popular entry page, and the like. Alternatively, user data related to an interaction between the user and the web page may be collected, including mouse movements, scrolling up or down a web page, resizing browser windows, click events, hover events, keyboard use, and the like. User data may further include the path or route a user takes during a visit to the website, including which pages are visited, in what order the pages are visited, a chronological list of items with which a user has interacted during a website visit, the buttons hovered over, and the buttons on which a user clicked, and the like.

However, these solutions merely offer a collection of statistics compiled from individual user visits. While an average of certain statistics, such as time spent on the website may be determined, averaging every user statistic can obscure vital information. For example, analyzing both a group of heavily active users of a website, who spend extended periods of time on web pages and engage with multiple elements of the website, together with a group of passive users, who only interact with the website in a limited basis, will frustrate the ability of a website owner to meaningfully understand the trends of the various groups, as the examples lying on either end of the activity spectrum may cancel each other out. The known solutions fail to provide a method of sequencing a journey of users through an online retail platform and providing useful information regarding users' activity within each retail platform.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for journeying user activity through an online retail platform. The method comprises analyzing pageviews recorded for each user of a plurality of users visiting a website; determining, for each user, a sequence of events recorded within each webpage visited; determining, for each user, a journey, wherein the journey is an order of webpage visits within the website; aggregating the determined sequences and the determined journeys across the plurality of users; and generating an intuitive map showing the aggregated journeys.

In addition, certain embodiments disclosed herein include a system for journeying user activity through an online retail platform. The system comprises a processing circuitry; and a memory, the memory containing instructions that, when executed by the processing circuitry, configure the system to: analyze pageviews recorded for each user of a plurality of users visiting a website; determine, for each user, a sequence of events recorded within each webpage visited; determine, for each user, a journey, wherein the journey is an order of webpage visits within the website; aggregate the determined sequences and the determined journeys across the plurality of users; and generate an intuitive map showing the aggregated journeys.

### BRIEF DESCRIPTION OF THE DRAWINGS

The subject matter of the disclosure is particularly pointed out and distinctly claimed in the claims at the conclusion of the specification. The foregoing and other objects, features and advantages will become apparent and more readily appreciated from the following detailed description taken in conjunction with the accompanying drawings, in which:

FIG. 1 shows a network diagram utilized to describe the various embodiments of the invention.

FIG. 2 is a flowchart illustrating a method for sequencing a journey through a website, according to one embodiment.

FIG. 3 is a flowchart illustrating a method for generating a digital representation of a journey of a user through a website platform, according to one embodiment.

FIG. 4 is an example screenshot showing a digital representation of journeys displayed on a dashboard.

FIG. 5 is a block diagram of an analytic system utilized to process and analyze interaction information of browsing activity according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

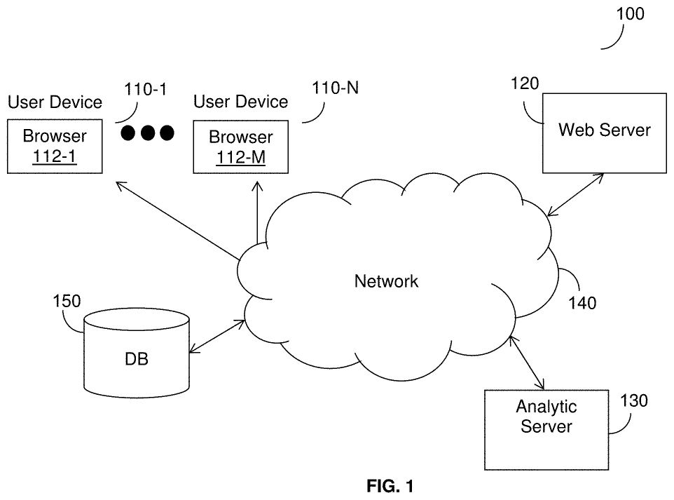

FIG. 1 shows an example diagram of a network system 100 utilized to describe the various embodiments. The network system 100 includes one or more user devices, 110-1 through 110-N (hereinafter, “user device” 110 or “user devices” 110), at least one web server 120, and an analytic server 130, all connected to a network 140. The analytic server 130 may be adapted to gather, process, and analyze engagement data, such as user activity information, related to the engagement of users of user devices 110 interacting with a website hosted by the web server 120. The user activity information may be received from one or more user devices 110. In an example embodiment, such websites include e-commerce websites, i.e., any website that offers goods, services, or both.

The network 140 provides interconnectivity between the various components of the system. The network 140 may be, but is not limited to, a wireless, cellular or wired network, a local area network (LAN), a wide area network (WAN), a metro area network (MAN), the Internet, the worldwide web (WWW), similar networks, and any combination thereof. The network 140 may be a full-physical network, including exclusively physical hardware, a fully-virtual network, including only simulated or otherwise-virtualized components, or a hybrid physical-virtual network, including both physical and virtualized components. Further, the network 140 may be configured to encrypt data, both at rest and in motion, and to transmit encrypted, unencrypted, or partially-encrypted data.

The network 140 may be configured to connect to the various components of the system 100 via wireless means such as, as examples and without limitation, Bluetooth long-term evolution (LTE), Wi-Fi, other, like, wireless means, and any combination thereof, via wired means such as, as examples and without limitation, ethernet, USB, other, like, wired means, and any combination thereof. Further, the network 140 may be configured to connect with the various components of the system 100 via any combination of wired and wireless means.

A user device 110 may be any computing device allowing a user to at least download web-pages, display web-pages, and interact with web-pages. A user device 110 may be, but is not limited to, a smart phone, a tablet computer, a personal computer, a laptop computer, a netbook computer, an electronic reader, and the like. A user device may include an installed web browser 112, such as Safari®, Firefox®, Internet Explorer®, Chrome®, and the like. A processor of the user device 110 runs an operating system such as, as examples and without limitation, iOS®, Android®, Unix®, Windows®, and the like. It should be noted that the browser 112 may include any mobile application executable over the user device 110, an extension of the browser 112, or both. Such an application is typically downloaded from a central repository (not shown) such as, as examples, AppStore® by Apple Computers®, Google® Play®, and the like.

The web server 120 can host a website accessed through a browser 112. The web server 120 may also execute one or more applications configured to provide functionalities and contents to a mobile application (not shown) executed over a user device 110. The teachings disclosed herein can be utilized to sequence an electronic journey (hereinafter, “a journey”) of a user of a user device, such as, without limitation, the user device 110, through a website platform, and for generating other analytics data based on the user's journey through Hypertext Markup Language (HTML) scripts of either the web pages of a website displayed over a browser, such as the browser 112, or the content displayed over a mobile application. The website may include an e-commerce website, an online retail platform, and the like. In some embodiments, the user devices 110 can access an application installed on and executed by the web server 120, the analytic server 130, or both. Such an application may include a mobile application (app), a cloud application, a web application, and the like. The various embodiments will be discussed herein with a reference to one or more websites, but they are equivalently applicable to one or more applications.

Without limiting the scope of the disclosed embodiments and merely for the sake of simplicity, the description hereinbelow will be made with reference to the browser 112. It should be further noted that the disclosed teachings are not limited to scripts retrieved from one server. The browser 112 may be configured to render or otherwise display content retrieved from a plurality of servers including, without limitation, web servers, application servers, other, like, servers, or any combination thereof.

Any webpage visited by the user device 110 and provided by the web server 120 includes a tracking tag. The tracking tag, when interpreted by a browser 112, executes a piece of code, such as, without limitation, a script, configured to track an interaction of a user with the web page. This includes a URL visited, any element in the page clicked on, or hovered over, by the user, time spent on a certain web page, and the like.

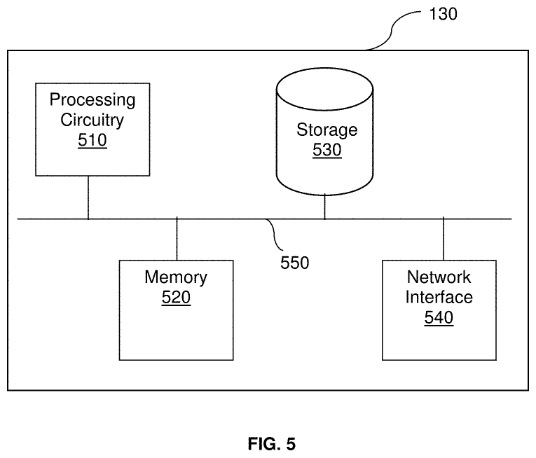

The analytic server 130, depicted in detail with respect to FIG. 5, below, is a system configured to execute instructions, organize information, and otherwise process data. The analytic server 130 may be configured to execute the methods described hereinbelow, other, like, methods, and any combination thereof. As described with respect to FIG. 5, below, the analytic server 130 may include various processing, memory, networking, and other components allowing the analytic server 130 to execute instructions and provide data processing. The analytic server 130 may be implemented as physical hardware, as software virtualizing physical hardware, or as a combination of physical and virtualized components. The analytic server 130 may be deployed in a cloud computing platform, in a data center, or on-premises, and the like.

According to the disclosed embodiments, the analytic server 130 is configured to receive browsing activity from any user device such as, for example, the user device 110, processing the tracking tag. A user of a user device 110 may visit a website including one or more webpages. While a web page is displayed in the browser 112, the user may perform various activities which may be monitored by the tracking tag. The interactions of a user within one webpage is referred to as a “pageview.” The browsing activity may include a number of pageviews such as, as examples and without limitation, pageviews for home pages, about pages, product pages, and the like.

The browsing activity may include, as examples and without limitation, a mouse movement, scrolling up or down web page, resizing a browser window, click events, keyboard use with any element of a webpage, and the like, as well as any combination thereof. The browsing activity may further include data describing a information including, without limitation, uniform resource locators (URLs), referrers, load times, IP addresses, browser types, screen resolutions, page views, and the like, as well as any combination thereof. In an embodiment, the browsing activity also includes a Document Object Model (DOM) tree of each pageview (a webpage visited by a user). The DOM is a cross-platform and language-independent interface that treats an XML or HTML document as a tree structure where each node is an object representing a part of the document. The DOM represents a document with a logical tree. The tracking tag “records” the structure of a webpage and the interactions of the user with each visited webpage.

The browsing activity from multiple users is tracked by the analytic server 130 and may be saved in a database 150, connected to the network 140. Each pageview is saved in association with the respective DOM of the page.

In an embodiment, the analytic server 130 is configured to aggregate the browsing activity based on pageviews. That is, some pageviews (webpages visited by different users) will be aggregated into the same group.

In an embodiment, the analytic server 130 is further configured to analyze the aggregated pageviews to determine at least one sequence of a journey for users visiting a website, and link each of the aggregated pageviews with the recorded DOM elements, structure, or both, providing for rendering of the webpage from the DOMs' elements, structures, or both to show interaction with the user device 110. According to one embodiment, based on the determined sequence, the analytic server 130 may be configured to generate a data structure such as, as an example and without limitation, a tree structure, demonstrating and visualizing the sequence of the journey or journeys.

In one embodiment, the analytic server 130 is further configured to sequence each detected journey in a chronological order. According to a further embodiment, the analytic server 130 may determine, for each phase of the journey, such as for each web page visited, interaction metrics, such as a number of clicks that led to the webpage, a number of clicks within the web page, a hover time on a specific element, an abandonment rate of the web page, and the like.

For example, the analytic server 130 may sequence a journey, such that it is determined that 2,000 users have visited a home page of a certain website and that, of the 2,000, 1,860 users clicked on the “menu” button while, of the 1,860, 1,600 users went to a “loan types” page and that, of the 1,600, 80 users spent more than 120 seconds on the “loan types” page while, of the eighty, and of them only 40 users clicked on a “take a loan” button during the session.

In an embodiment, the analytic server 130 is further configured to generate analytics with respect to an in-page sequence, namely, an in-page interaction. The analytics may indicate, for example, a number of clicks on an element, a number or duration of hovers over an element, scroll events, mouse movements, text selections, and the like.

In an embodiment, each journey may be linked with a respective recorded session replay. A session replay may include recordings recorded for visitors engaging with website to be analyzed. Where a session is selected and linked with a specific journey, the selected session may be provided to an administrator, supervisor, or other user as a video output displayed on a user device, such as the user device 110, providing for replay and review of sessions in which interaction metrics are recorded.

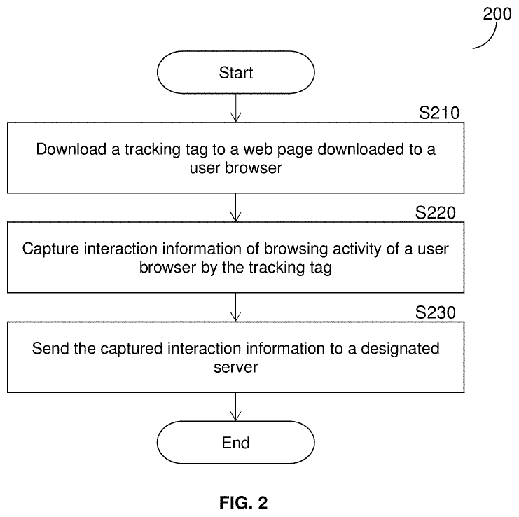

FIG. 2 is an example flowchart 200 illustrating a method for sequencing a journey through a website, according to one embodiment.

At S210, a tracking tag such as, for example, a tracking script, is downloaded to a webpage, where the webpage is or was downloaded to the browser that is utilized by a user device, such as the user device, 110, of FIG. 1, above. The tracking tag may be part of the webpage content retrieved from the web server, or may be embedded in a mobile application. The downloaded tracking tag is saved in a tangible memory of the user device and executed thereon. In one embodiment, the tracking tag (e.g., the tracking script) is realized as a JavaScript. The tracking tag enables tracking and monitoring interaction information of browsing activity of a user associated with a user device.

At S220, browsing activity during a session of a user's browser is captured by the tracking tag. The captured browsing activity for each pageview may be indicative of a mouse movement, scrolling up or down a webpage, resizing a browser window, click events, keyboard use with any element of a webpage, and the like, as well as any combination thereof. The browsing activity may further include URLs, referrers, load times, IP addresses, browser types, screen resolutions, page views, and the like. The captured browsing activity may also include the DOM of each pageview during the session.

At S230, the captured browsing activity is sent over a network, such as the network, 140, of FIG. 1, above, to a designated server, such as the analytic server, 130, of FIG. 1, above, to generate journeys from data gathered by multiple users.

When the captured browsing activity is received at the server, the server, such as the server, 130, of FIG. 1, above is configured to record the captured browsing activity as an activity session of a user. The session activity is recorded using the DOM elements visited during each pageview. It should be noted that neither video nor images of the browsing sessions being recorded.

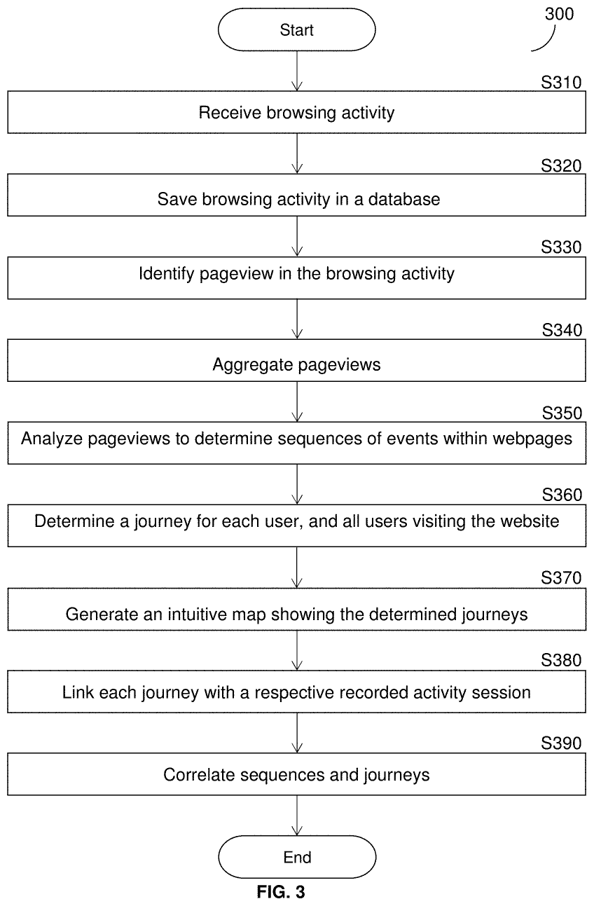

FIG. 3 shows an example flowchart 300 illustrating a method for generating a digital representation of a journey of a user through a website platform, according to one embodiment.

In an embodiment the method is performed by the analytic server, 130, of FIG. 1, above. The website may include, but is not limited to, an e-commerce website, an online retail platform, and the like.

At S310, browsing activity of at least one user browser is received. The browsing activity may be received over time, as gathered by the at least one user device, or as batch data. The received browsing activity may include the pageviews, that is, the interaction of a user within each webpage. A pageview may include one or more interaction events, including actions or activities, regarding the interaction of user with a webpage. An event may be, as examples and without limitation, a click event, a hover event, a scroll event, a mouse movement event, a text selection event, and the like. The received browsing activity includes the DOM elements and structure of each visited webpage. At S320, the received browsing activity is saved as an activity session of the user. That is, the DOM elements and structure are saved. An entry may be associated with a user ID or other, anonymized user identifiers.

At S330, for each user device, each pageview is identified in the browsing activity. At S340, the browsing activity is aggregated based on pageviews. The aggregation or clustering may include of grouping all pageviews of the same URL. That is, all pageviews of a specific webpage visited by multiple different users are aggregated.

At S350, the aggregated pageviews are analyzed to determine a sequence of events within a webpage by analyzing each pageview, providing a sequence of events within a webpage. For example, a user first hovers over an image and then clicks on the image. The determined sequences of events are also aggregated across a number of webpages visited by multiple users.

In an embodiment, S350 further includes analyzing the aggregated pageviews to compute engagement metrics across pageviews. To this end, first, for each pageview, the URL of the page visited is determined. Next, an engagement metric for each event occurring on the webpage is computed. Finally, engagement metrics for the same events are aggregated. It should be noted that an engagement metric may be computed on each element of the page, such as, for example, the number of clicks on a “subscribe” button on a subscription webpage. Such analysis may indicate the number of clicks on the subscription webpage across a number of pageviews recorded for different users. An event includes an action or activity performed by a user on a webpage.

At S360, a journey, which is the order of webpages visited by users, is determined. In an embodiment, S360 includes analyzing the pageviews for each user to determine a journey per user. The journeys determined for multiple users are aggregated.

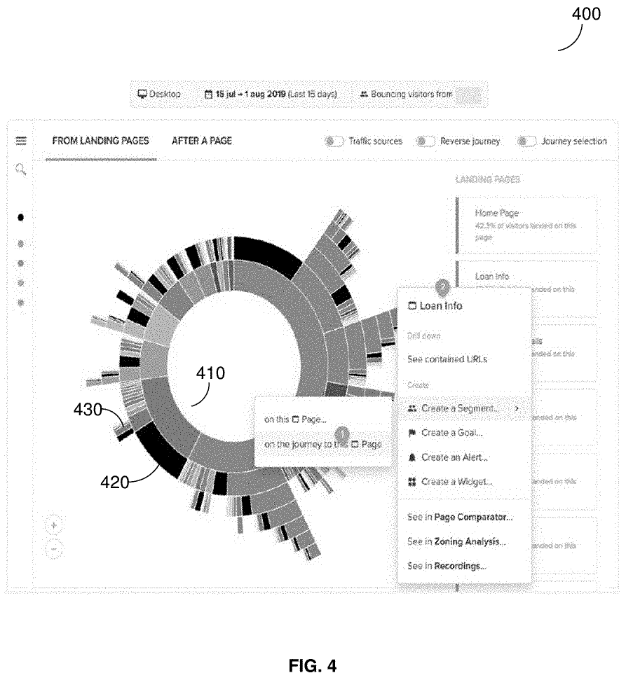

At S370, an intuitive map showing the determined journeys is generated. The generated map may also include the determined sequences. An example screenshot showing an intuitive map, generated according to an embodiment, is shown in FIG. 4.

At S380, each journey determined for a user is linked or otherwise associated with a respective recorded activity session to provide a session replay. A session replay, when activated, includes retrieving the DOM elements, and other webpage resources, from the database, and rendering or recording the sessions.

It should be noted that, when a session is selected and linked with a specific journey, the selected session may be rendered and played to an administrator, supervisor, or other user on a user device, such as the user device, 110, of FIG. 1, above, providing for replay and review of sessions in which interaction metrics are recorded. The resources may include, for example and without limitation, images, banners, video clips, and the like which may be included in the website, but which are not included in the associated DOM.

At S390, the determined sequences can be correlated with the determined journeys. Such correlation provides for derivation of the sequence of events causing a user, or group of users, to navigate from one page to another.

FIG. 4 is an example screenshot 400 showing a digital representation of journeys displayed on a dashboard. The digital representation, a digital and circular map, depicts several sequential segments that represent web pages, which multiple users have visited in a chronological order. For example, segment 410 relates to the “loan information” web page, a landing page, and indicates the number of visitors to this web page. Segment 420 represents the number of visitors, to a “loan for business” web page, who visited the “loan information” page prior to visiting the “loan for business” page. Segment 430 shows the number of visitors, to a “loan for small business” web page, who have visited the “loan for business” page prior to visiting the “loan for small business” page. Thus, a journey that shows the user browsing activity is created.

FIG. 5 is an example schematic diagram of an analytic server 130, according to an embodiment. The analytic server 130 includes a processing circuitry 510 coupled to a memory 520, a storage 530, and a network interface 540. In an embodiment, the components of the analytic server 130 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 520 may be volatile (e.g., random access memory, etc.), non-volatile (e.g., read only memory, flash memory, etc.), or a combination thereof.

In one configuration, software for implementing one or more embodiments disclosed herein may be stored in the storage 530. In another configuration, the memory 520 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 540 allows the analytic server 130 to communicate with the various components, devices, and systems described herein for the sequencing of journeys through a website, and for other, related, purposes.

It should be understood that the embodiments described herein are not limited to the specific architecture illustrated in FIG. 5, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method of journeying user activity through an online retail platform, comprising:
analyzing pageviews recorded for each user of a plurality of users visiting a website;
determining, for each user, a sequence of events recorded within each webpage visited;
determining, for each user, a journey, wherein the journey is an order of webpage visits within the website;
aggregating the determined sequences and the determined journeys across the plurality of users; and
generating an intuitive map showing the aggregated journeys.

2. The method of claim 1, further comprising:
analyzing pageviews recorded for each user to determine at least one engagement metric; and
aggregating the at least one engagement metric across the plurality of users.

3. The method of claim 1, further comprising:
correlating the determined journeys with the determined sequences to derive in-page activity causing to users to navigate from one webpage to another webpage.

4. The method of claim 1, further comprising:
receiving document object model (DOM) elements of each webpage visited;
storing the DOM elements in a database; and
associating the stored DOM elements with a respective journey determined for the user.

5. The method of claim 4, further comprising:
upon receiving a replay request, retrieving the DOM elements from the database;
gathering resources included in the webpage; and
rendering the respective journey from the DOM elements and gathered resources.

6. The method of claim 1, wherein each pageview includes a set of events, wherein each event is at least an interaction action of a user with a webpage.

7. The method of claim 6, wherein an event includes any one of: a click event, a hover event, a scroll event, a mouse movement event, and a text selection event.

8. A non-transitory computer readable medium having stored thereon instructions for causing a processing circuitry to perform a process, the process comprising:
analyzing pageviews recorded for each user of a plurality of users visiting a website;
determining, for each user, a sequence of events recorded within each webpage visited;
determining, for each user, a journey, wherein the journey is an order of webpage visits within the website;
aggregating the determined sequences and the determined journeys across the plurality of users; and
generating an intuitive map showing the aggregated journeys.

9. A system for journeying user activity through an online retail platform, comprising:
a processing circuitry; and
a memory, the memory containing instructions that, when executed by the processing circuitry, configure the system to:
analyze pageviews recorded for each user of a plurality of users visiting a website;
determine, for each user, a sequence of events recorded within each webpage visited;
determine, for each user, a journey, wherein the journey is an order of webpage visits within the website;
aggregate the determined sequences and the determined journeys across the plurality of users; and
generate an intuitive map showing the aggregated journeys.

10. The system of claim 9, wherein the system is further configured to:
analyze pageviews recorded for each user to determine at least one engagement metric; and
aggregate the at least one engagement metric across the plurality of users.

11. The system of claim 9, wherein the system is further configured to:
correlate the determined journeys with the determined sequences to derive in-page activity causing to users to navigate from one webpage to another webpage.

12. The system of claim 9, wherein the system is further configured to:
receive document object model (DOM) elements of each webpage visited;
store the DOM elements in a database; and
associate the stored DOM elements with a respective journey determined for the user.

13. The system of claim 12, wherein the system is further configured to:
upon receiving a replay request, retrieve the DOM elements from the database; and
gather resources included in the webpage; and
render the respective journey from the DOM elements and gathered resources.

14. The system of claim 9, wherein each pageview includes a set of events, wherein each event is at least an interaction action of a user with a webpage.

15. The system of claim 14, wherein an event includes any one of: a click event, a hover event, a scroll event, a mouse movement event, and a text selection event.
